(19) United States
(12) Patent Application Publication
(10) Pub. No.: US 2018/0056218 A1
(43) Pub. Date: Mar. 1, 2018

(54) Filter Housing of an Exchangeable Filter, Filter, Connecting Device, and Filter Device

(71) Applicant: MANN+HUMMEL GmbH, Ludwigsburg (DE)

(72) Inventors: Michael Fasold, Auenwald (DE); Ulrich Dehnen, Kornwestheim (DE); Stefan Kunze, Tuebingen (DE); Christopher Marc Sturgess, Korntal (DE); Alexander Woell, Calw (DE); Christian Vogt, Ludwigsburg (DE); Matthias Osswald, Markgroeningen (DE); Heinz Dobusch, Freudental (DE); Stefan Uhl, Fellbach (DE)

(21) Appl. No.: 15/694,113

(22) Filed: Sep. 1, 2017

(30) Foreign Application Priority Data
Sep. 1, 2016 (DE) 102016010523.2

(51) Int. Cl. B01D 35/30; B01D 35/00

(52) U.S. Cl. CPC B01D 35/306; B01D 2201/30; B01D 35/005

(57) ABSTRACT

A filter housing has a housing pot accommodating a filter element. The filter housing has a connecting element connectable by a rotary and/or plug-in connection for connecting the filter with a connecting device. The filter housing has a securing ring forming a cup-shaped attachment section with a circumferential free rim. By rotary and/or plug-in movement, the attachment section is attached to an insertion section of the connecting device. The attachment section is provided with a sealing receptacle of a circumferential sealing device. The sealing receptacle is open in radial inward direction and has a radial sealing surface. The attachment section is connected at the free rim with the circumferential wall of the housing pot by crimping. The securing ring provides a first axial stop surface for an annular seal. A stop ring, inserted into the securing ring, provides a second axial stop surface for the annular seal.

### BACKGROUND OF THE INVENTION

The invention concerns a filter housing of an exchangeable filter of a filter device for liquids, in particular oil, fuel, hydraulic fluid, water or the like, in particular of an internal combustion engine, in particular of a motor vehicle, wherein the filter housing comprises a housing pot in which at least one filter element is arranged, wherein the filter housing comprises at least one filter-associated connecting element that is connectable by a rotary and/or plug-in connection relative to the virtual connecting axis for connecting the filter with a connecting device of the filter device. The filter housing comprises at least one part of a circumferential sealing device that is sealingly acting at least radially. The filter housing at an end face comprises a cup-like attachment section that at its open side has a circumferential free rim and, by means of a rotary and/or plug-in movement relative to the connecting axis, the filter housing can be attached with the cup-like attachment section to a corresponding insertion section of the connecting device, wherein in the attachment section a sealing receptacle is present that is open in radial inward direction and comprises a radial sealing surface pointing radial inwardly for supporting at least one annular seal.

Moreover, the invention concerns an exchangeable filter of a filter device for liquids, in particular oil, fuel, hydraulic fluid, water or the like, in particular of an internal combustion engine, in particular of a motor vehicle, with at least one filter housing, wherein the filter housing comprises a housing pot in which at least one filter element is arranged, wherein the filter housing comprises at least one filter-associated connecting element that is connectable by a rotary and/or plug-in connection relative to the virtual connecting axis for connecting the filter with a connecting device of the filter device. The filter housing comprises at least one part of a circumferential sealing device that is sealingly acting at least radially. The filter housing at an end face comprises a cup-like attachment section that at its open side has a circumferential free rim and, by means of a rotary and/or plug-in movement relative to the connecting axis, the filter housing can be attached with the cup-like attachment section to a corresponding insertion section of the connecting device, wherein in the attachment section a sealing receptacle is present that is open in radial inward direction and comprises a radial sealing surface pointing radial inwardly for supporting at least one annular seal.

Also, the invention concerns a connecting device of a filter device for connecting an exchangeable filter for liquids, in particular oil, fuel, hydraulic fluid, water or the like, in particular of an internal combustion engine, in particular of a motor vehicle, wherein the connecting device comprises at least one connection-associated connecting element that is connectable by a rotary and/or plug-in connection relative to the virtual connecting axis for connecting the filter, and further comprises at least a part of a circumferential sealing device that is acting sealingly at least radially. The connecting device further comprises an end-face insertion section to which by means of a rotary and/or plug-in movement relative to the connecting axis a cup-shaped attachment section of a filter housing of the filter can be attached.

Moreover, the invention concerns a filter device with at least one connecting device and at least one filter.

U.S. Pat. No. 7,434,697 B2 discloses a dispensable spin-on liquid filter. The liquid filter is configured and designed for attachment on a base member that is designed with a fastening shaft provided with a thread. The base member provides a fluid inlet flow to the filter and a fluid outlet path away from the filter. The filter construction comprises a housing container which comprises a closed end and an oppositely positioned open end and a fluid filter medium that is arranged in the housing container.

### SUMMARY OF THE INVENTION

The invention has the object to configure a filter housing, a filter, a connecting device, and a filter device of the aforementioned kind in which the sealing device between the filter housing and the connecting device can be improved, in particular a mountability can be simplified and/or seal tightness can be improved.

This object is solved according to the invention in that in the attachment section a securing ring is present which at the free rim of the attachment section is connected with the circumferential wall of the housing pot by means of a crimp connection, wherein the securing ring provides a first at least part-circumferential axial stop surface for the annular seal and, from the free rim end, a stop ring can be inserted into the securing ring to provide a second at least part-circumferential axial stop surface for the annular seal.

According to the invention, in the attachment section a securing ring is present which is connected with a circumferential wall of the housing pot. By means of a crimp connection, a seal-tight and stable connection can be realized. The securing ring provides a first at least part-circumferential axial stop surface for the annular seal. Moreover, from the free rim end, a stop ring is inserted into the securing ring. This stop ring provides a second at least part-circumferential axial stop surface for the annular seal. In this way, a sealing groove that is open in radial inward direction for the radially acting annular seal is realized by a two-part solution.

Advantageously, the securing ring can be a metal ring. In this way, it can be manufactured simply in particular by forming.

Advantageously, the securing ring can form a second axial stop shoulder for an annular seal. The second stop shoulder or stop surface can act as a stripper for the annular seal. Accordingly, when demounting the filter from the connecting device, in particular in case of servicing, the annular seal can be automatically pulled off from an appropriate flange, in particular the insertion section of the connecting device.

Advantageously, the annular seal can be realized as an O-ring seal. O-ring seals can act seal-tightly in radial direction.

Advantageously, a circumferential wall of the securing ring that is extending circumferentially relative to the connecting axis, in particular of the attachment section, can be connected with its free rim with a free rim of a circumferential wall of a housing pot of the filter housing, in particular by means of a crimp connection. In this way, the securing ring, in particular the attachment section, can be fixedly connected with the housing pot.

The filter housing comprises on its end face a cup-shaped attachment section. For connecting the filter housing with the connecting device, the cup-shaped attachment section can be attached by means of a rotary and/or plug-in movement to the insertion section of the connecting device. The rotary and/or plug-in movement can be a pure plug-in movement, a combined rotary/plug-in movement, in particular a screwing movement, or a plug-in movement with subsequent rotary movement, known in particular for closing a bayonet-type connection, or the like.

In the mounted state, the attachment section can engage circumferentially at least partially, in particular circumferentially continuously, around the insertion section of the connecting device. In this way, the attachment section can support the insertion section in radial direction outwardly relative to the connecting axis.

Advantageously, the attachment section, the insertion section, and the at least one connecting element can be coaxial to the connecting axis. In this way, forces, in particular rotary forces which are applied upon connecting the filter, can be introduced more uniformly into the connecting device.

Advantageously, the insertion section and the attachment section can be comprised of different materials or comprise different materials. In this way, the two components can be optimized in regard to material selection in relation to their respective function and/or their manufacturability.

Advantageously, at least the attachment section can comprise or be comprised of a material which is mechanically more stable than the material of the insertion section. In this way, the mechanical stability of the insertion section can be improved with the cup-shaped attachment section.

Advantageously, the insertion section can be comprised of plastic material, in particular polymer, or comprise plastic material. Plastic parts can be produced in a simple way, in particular by means of appropriate injection molding processes. The insertion section can serve as a plastic counter flange for the filter, in particular the attachment section.

Advantageously, the attachment section can be made of metal or can comprise metal. A high mechanical stability can be achieved by metal.

Advantageously, the attachment section can comprise at a circumferential wall at least one circumferential filter-associated radial sealing surface for supporting at least one radially acting annular seal. In the context of the invention, “filter-associated” means “belonging to the filter”, if nothing different is mentioned. Correspondingly, “connection-associated” means “belonging to the connecting device”, if nothing different is mentioned. The filter-associated radial sealing surface and the at least one annular seal form at least partially a circumferential sealing device. Radially acting annular seals can be mounted relative to an axial position with more position tolerance in comparison to purely axially acting seals.

Moreover, in case of an in particular operation-caused radial expansion of the insertion section, radially acting annular seals can be pressed more strongly against corresponding radial sealing surfaces. In this case, a sealing action can be augmented.

Due to the radially acting sealing device, between the filter and the insertion section a plastics-appropriate sealing action can be provided. Also, in particular operation-caused deformations of the insertion section can be compensated with the radially acting sealing device according to the invention. Such deformations can be caused in particular by high operating temperatures and applied loads. In contrast to this, a purely axially acting sealing device, due to groove fillings of a sealing groove, can generate very high sealing reaction forces which, in connection with an insertion section of plastic material, can have negative effects in that the insertion section under temperatures and the applied load, in particular the sealing reaction force, can become permanently deformed and thus cause leakage of the system.

Advantageously, the at least one circumferential sealing device can act to seal relative to the environment at least in radial direction relative to the connecting axis. In this way, at least an interior of the filter housing can be sealed with the at least one sealing device relative to the environment.

Advantageously, the filter housing cannot be opened non-destructively. Filters with such filter housings can be referred to as exchangeable filters or spin-on filters. At least one filter element can be arranged in the filter housing so that it cannot be exchanged non-destructively. Alternatively, the filter can comprise an openable filter housing in which, in particular exchangeably, at least one filter element can be arranged.

The attachment section, in particular the securing ring, and/or the stop ring form at least partially at least one circumferential sealing receptacle, open in radial inward direction relative to the connecting axis, for a radially acting annular seal. The annular seal can be simply inserted, positioned and/or secured in the sealing receptacle.

At least one sealing receptacle comprises, at least on the side that is axially facing away from the end face of the attachment section and/or on its side that is facing axially the end face, at least one at least part-circumferential filter-associated stop area for the at least one annular seal. In this way, it can be prevented that the annular seal on the corresponding side can axially escape from the sealing receptacle in axial direction.

The attachment section, in particular the securing ring, comprises a first filter-associated stop area for the at least one annular seal in axial direction. The first filter-associated stop area can be realized by a corresponding stamped portion or formed portion of the attachment section.

The second axial stop area is realized axially opposite to the first filter-associated stop area. By means of the second axial stop area, it can be ensured that the at least one annular seal upon removal of the filter, in particular in the context of servicing or service exchange, remains on the filter, in particular in the filter-associated sealing receptacle. In this way, it can be prevented that the annular seal stays on the insertion section when the filter is removed.

In the area of the free rim of the attachment section, a stop element, in particular the stop ring, is arranged. By means of the filter-associated stop element, a second filter-associated axial stop area can be formed.

The filter-associated stop element can comprise advantageously plastic material and/or metal, in particular can be formed from it.

Advantageously, the filter-associated stop element can be realized as a separate component, in particular as a ring element.

Advantageously, the filter-associated stop element can be connected detachably, in particular by means of a locking connection or clamping connection, or so that it cannot be removed non-destructively, in particular by means of a weld connection, adhesive connection, or a crimp connection, to the attachment section and/or to a housing pot of the filter housing and/or to a connection, in particular a crimp connection, of the attachment section with the housing pot.

Alternatively, the second axial stop area can be arranged on the insertion section. In this case, the second axial stop area can be formed in particular by a coaxial shoulder or by a web. The second axial stop area, viewed in axial direction, can be arranged above the annular seal. The second filter-associated stop area can advantageously be immersed in the filter-associated sealing receptacle upon attachment of the filter.

Advantageously, the insertion section can comprise, on its free side which is facing the filter, a connection-associated guide section. At least one filter-associated annular seal can be guided on the guide section upon attachment of the attachment section to the insertion section. The connection-associated guide section can be located on its radial outer rim relative to the axis. It can be realized in the form of a rounded portion or bevel.

Advantageously, at least one annular seal of the sealing device can be arranged, in particular positioned, secured or fastened, in particular pre-mounted, on the filter housing, in particular of the attachment section. The filter housing can be attached with the attachment section together with the annular seal to the insertion section. Alternatively or additionally, at least one annular seal can be arranged, in particular positioned, secured or fastened, in particular pre-mounted, on the connecting device, in particular on the insertion section.

Advantageously, at least one filter-associated connecting element and/or a connection-associated connecting element can comprise at least one connecting opening or can be comprised thereof. Advantageously, at least one respectively matched connection-associated connecting element and/or filter-associated connecting element can comprise at least one connecting socket or can be comprised thereof. For connecting the connecting device, a connecting socket can be simply introduced by means of a rotary and/or plug-in movement into a connecting opening.

The connecting elements that are matched to each other can advantageously comprise at least one connecting section, respectively, for realizing a rotary and/or plug-in connection. At least one connecting section can advantageously comprise a thread and/or at least a part of a bayonet-type connection. By means of threads the connecting elements can be simply screwed to each other.

At least one connection-associated connecting element can advantageously be connected as a multiple part configuration with the insertion section. In this way, the insertion section and the at least one connection-associated connecting element can be each designed separately with regard to benefits regarding function and/or manufacturing technology.

Advantageously, at least one connection-associated connecting element can comprise other materials than the insertion section. Advantageously, at least one connection-associated connecting element can comprise metal or can be comprised thereof. In this way, the advantages of different materials, i.e., the stability of the metal and the minimal weight and the simple processability of the plastic material, can be combined with each other.

At least one connection-associated connecting element can be introduced into the insertion section in particular of plastic material at least over sections thereof, in particular embedded therein.

Advantageously, at least one connecting socket can comprise a continuous interior in the direction of its longitudinal axis. With the interior of the connecting socket, at least a part of a fluid conduit can be realized.

Advantageously, at least one filter-associated connecting element of the filter housing can be realized in connection with a housing cover of the filter housing. With the housing cover, a housing pot of the filter housing can be closed off after introduction of at least one filter element.

Advantageously, the filter housing can comprise at least one liquid passage for liquid to be filtered and at least one liquid passage for filtered liquid. In this way, the liquid to be filtered can be introduced into the liquid housing and the filtered liquid can be discharged from the liquid housing.

Advantageously, the at least one filter element is arranged or can be arranged in the filter housing in such a way that it separates the at least one liquid passage for liquid to be filtered from the at least one liquid passage for filtered liquid. In this way, the liquid is mandatorily guided through the filter element.

Advantageously, the at least one filter-associated connecting element can form at least partially a liquid passage for liquid. In this way, the at least one connecting element can realize the function of the mechanical connection as well as that of the fluid connection. The number of required components can thus be reduced. Moreover, the corresponding fluid connection can be realized in a space-saving way.

Advantageously, the housing cover can comprise at least one liquid passage for passage of the liquid to be purified or of the purified liquid. At least one liquid passage of the filter housing can be realized with the at least one filter-associated connecting element on/in the housing cover.

Advantageously, the cup-shaped attachment section can be arranged in an installation opening of the housing pot for at least one filter element. In this way, the attachment section can be integrated in a space-saving way in the housing pot.

The filter can advantageously be part of a motor oil circuit of an internal combustion engine of a motor vehicle. The filter can advantageously be a motor oil filter of the internal combustion engine. It can serve for purifying motor oil which is supplied to the internal combustion engine. Alternatively, the filter can be part of a fuel system, in particular of a fuel circuit, of an internal combustion engine of a motor vehicle. The filter can serve as a fuel filter for purifying fuel, in particular gasoline or diesel fuel, which is supplied to the internal combustion engine for combustion. Motor vehicles in the context of the invention can be land vehicles, watercraft and/or aircraft.

The invention is however not limited to a motor oil filter or a fuel filter of an internal combustion engine of a motor vehicle. Instead, it can also be employed in other types of liquid systems, in particular hydraulic systems, cooling systems, aqueous urea systems or the like, of motor vehicles or other machines, in particular agricultural machines or construction machines. The invention can also be used outside of automotive technology, in particular in industrial motors.

In an advantageous embodiment, the securing ring can be formed to closely follows the circumferential wall of the housing pot in a first section near the free rim of the attachment section with a predetermined axial extension and comprises a substantially cylindrical cross section and, in a second section that is facing away from the free rim, can have a reduced diameter section that can form the first at least part-circumferential axial stop surface for the annular seal. In this way, the stability of the attachment section can be improved. Moreover, in this way it is more easily possible to provide a holding-up action with a crimping tool for realizing the crimp connection between the securing ring and the circumferential wall of the housing pot.

Advantageously, a circumferential wall of the securing ring that is circumferentially extending relative to the connecting axis can be in particular contacting without a gap the radial inner circumferential side of the circumferential wall of the housing pot. In this way, the stability can be further improved.

In a further advantageous embodiment, the stop ring can be pressed in from the end face end of the filter housing into the securing ring or, by means of a different method, for example, welding, can be fastened captively on the free rim and/or can have a substantially Z-shaped cross section, wherein a leg of the Z which is extending perpendicular to the connecting axis can form the second stop surface for the annular seal, wherein the leg can be in an axial position where, in radial direction externally, the crimp connection can be positioned and/or the stop ring advantageously does not project farther into the securing ring in axial direction than the crimp connection extends in axial direction away from the free rim. In this way, the stability can be further improved as a whole. Moreover, the connecting device can thus be realized in a space-saving way. Moreover, the cross section of the stop ring can also be of an L shape, wherein a circumferential wall surface section of the stop ring is connected with an oppositely positioned inner wall surface section of the securing ring, for example, by welding, in particular by spot welding. This embodiment saves more material because the collar is not needed which otherwise in the embodiment with Z-shaped cross section is provided for contacting the formed crimp with form fit.

The securing ring can be pressed into the housing pot. In this way, it can be stably secured in the housing pot.

In a further advantageous embodiment, the crimp connection can comprise a crimp which is bent in radial direction outwardly and which on the free rim cannot produce an inner cross section restriction relative to the circumferential wall of the housing pot. In this way, assembly can be further simplified.

In a further advantageous embodiment, the filter housing can be provided at the open end face with a securing sleeve that can be arranged coaxially in the attachment section and that can have a central opening that is configured to at least partially receive in a mounted state a connecting element of the connecting device of the filter device. In this way, the at least one connecting element can be inserted and/or held in the securing sleeve. In this way, assembly can be simplified and/or a stability of the connection can be improved.

In a further advantageous embodiment, the securing sleeve and the securing ring can be formed together as one piece, preferably as a coaxial bulge of the securing ring, wherein the securing ring preferably can be realized as a formed part. In this way, the securing sleeve together with the securing ring can be more easily pre-manufactured and/or mounted.

Advantageously, at least the attachment section can be realized on/with a formed part. The at least one attachment section can be produced in a simple way as a formed part. The formed part can be formed from a primary-shaped forming material.

Advantageously, the formed part can be made of metal, in particular sheet metal. Metals can be formed simply by bending. Sheet metal pieces can be realized with relatively thin wall thicknesses. They can be easily bent, cut, stamped, welded, soldered or the like.

At least the attachment section, instead of being made of metal, in particular sheet metal, can also be made of another stable or stabilizing material, in particular of a composite material or can comprise it.

At least the attachment section can also be realized in different ways instead of being realized as or in connection with a formed part.

Advantageously, the filter housing, in particular the attachment section, the securing ring with the attachment section, the housing pot and/or the housing cover can comprise or be comprised of at least one formed part.

In a further advantageous embodiment, the securing sleeve in axial direction can extend at least to the level of the circumferential free rim of the attachment section and preferably can end at the same level as the rim of the attachment section. In this way, a manufacture of the filter housing and/or mounting of the filter/filter housing on the connecting device can be simplified. Moreover, a stability of the connection with the connecting device can be improved in this way.

Advantageously, the side of the securing sleeve that is axially facing away from the securing ring relative to the connecting axis and a rim of the crimp connection between the attachment section, in particular the securing ring, and the circumferential wall of the housing pot can be positioned axially approximately at the same level. In this way, an improved force introduction can be achieved.

In a further advantageous embodiment, the opening can be provided in an end face of the securing sleeve, wherein the rims of the securing sleeve that delimit the opening form a part of an anti-rotation securing device whose other part can be present at the connecting element of the connecting device. In this way, the anti-rotation securing device can be secured simply by insertion of the connecting element into the opening of the securing sleeve.

Advantageously, the radial inner rim of the securing sleeve can engage a corresponding annular groove of the connecting element, in particular of a connecting socket, of the connecting device. In this way, a simple anti-rotation securing device that is load-resistant to axial pull can be realized for the connecting element.

In a further advantageous embodiment, the securing element can be designed to be resilient at least in axial direction and preferably can be comprised of a resilient material and/or can have a geometry that can favor resilient properties, particularly preferred can be comprised of a thin-walled sheet metal. In this way, by means of the securing sleeve, a tolerance compensation in particular for manufacture-caused and/or operation-caused tolerances can be realized. The securing sleeve can engage the connecting element and can realize in this way an elastic mechanical pretension acting in axial direction relative to the connecting axis.

In a further advantageous embodiment, the attachment section can widen toward the free rim in radial outward direction, wherein preferably the widened portion can be present in a section that, viewed axially relative to the connecting axis, is located between the second axial stop surface for the annular seal and the free rim of the circumferential wall of the housing pot. In this way, mounting of the filter housing on the connecting device can be simplified.

Advantageously, a circumferential wall of the attachment section that extends circumferentially relative to the connecting axis can widen in radial outward direction toward its free rim, viewed relative to the connecting axis in axial direction.

In this way, the attachment of the attachment section on the insertion section of the connecting device can be simplified. The attachment section can thus realize an insertion slant, mounting, guiding and/or positioning aid. The at least one annular seal and the filter-associated radial sealing surface can thus glide more easily across each other and align each other, in particular become centered, during the rotary and/or plug-in movement for attaching the attachment section on the insertion section.

Advantageously, a circumferential wall of the attachment section that extends circumferentially relative to the connecting axis can widen in radial outward direction in a section that, viewed axially relative to the connecting axis, is located between the filter-associated radial sealing surface and the free rim of the circumferential wall. In this way, the filter-associated radial sealing surface can extend substantially cylindrical. The widening section upon attachment of the attachment section to the insertion section can serve as a mounting, guiding and/or positioning section and can be named as such.

In a further advantageous embodiment, the filter can be a spin-on filter, in particular a spin-on filter with a housing pot of sheet metal. The filter housing with the filter element can thus be produced together and exchanged together. The housing pot of sheet metal can be realized in a simple way, in particular as a formed part.

In a further advantageous embodiment, the filter can comprise a housing cover on which the connecting element can be present wherein the housing cover can be connected to the housing pot by means of the securing ring. In this way, several functions can be realized on the housing cover.

Advantageously, the attachment section can be part of the securing ring for holding a housing cover on a housing pot of the filter housing. In this way, the function of the attachment section for connecting the filter, in particular the filter housing, with the connecting device can be combined with the function of holding the housing cover on the housing pot. In this way, the component expenditure can be reduced.

The securing ring with the attachment section and the housing cover can be manufactured as separate components. The housing cover can be secured on the filter housing with the securing ring.

In a further advantageous embodiment, the securing ring can comprise at least one fixation element for fixation of a housing cover, preferably, a bent tab which can engage behind the housing cover, wherein particularly preferred a plurality of circumferentially distributed tabs can be provided that each can engaging through a through opening of the cover. In this way, additional fixation means on the housing cover for direct fixation thereof on the housing pot can be eliminated. Thus, the housing cover can be more simply designed and produced. Other connecting types between housing cover and securing ring, for example, spot welding or gluing, can be used alternatively.

Advantageously, at least one fixation element can be connected to the attachment section for fixation of a housing cover of the filter housing.

Advantageously, at least one fixation element can comprise at least one tab or be a tab. At least one fixation element can be bendable or can be bent. In this way, the at least one fixation element can be bent for fixation of the housing cover. The at least one fixation element can engage appropriate openings or through openings of the housing cover, in particular liquid through openings. In this way, openings provided anyway in the housing cover can be used for fixation.

Advantageously, at least one fixation element can be arranged on at least one securing ring. The securing ring can comprise the attachment section. In this way, the at least one fixation element can be connected with the attachment section.

In a further advantageous embodiment, the securing ring can comprise a bottom section on which the cover at least with sections thereof can be resting, wherein preferably the bottom section comprises at least one filter-associated projection that is axially raised relative to the connecting axis and is configured for supporting at least one corresponding connection-associated section associated with the connecting device.

Advantageously, a bottom section of the attachment section can comprise at least one filter-associated part that is axially raised relative to the connecting axis for supporting at least one corresponding connection-associated section associated with the connecting device. The corresponding connection-associated section associated with the connection device can be supported on the filter-associated projection.

A connection-associated section can advantageously be realized with at least one web that is at least part-circumferentially extending relative to the connecting axis. The connection-associated section can advantageously be supported on the filter-associated projection in radial direction relative to the connecting axis.

The filter-associated projection can be realized by a corresponding step in the bottom section of the attachment section.

Advantageously, at least one filter-associated projection can be arranged radially within the radial sealing surface relative to the connecting axis. In this way, the at least one projection can constitute an oppositely positioned counter bearing relative to the circumferential wall of the connecting attachment section, viewed in radial direction.

Advantageously, the at least one connection-associated section, in particular the web, can comprise a connection-associated radial sealing surface for supporting the radially acting annular seal. When the filter housing is mounted, the connection-associated radial sealing surface can be positioned opposite the filter-associated radial sealing surface of the circumferential wall of the attachment section.

Moreover, the technical object is solved for the filter according to the invention in that in the attachment section a securing ring is present which is connected at the free rim of the attachment section with the circumferential wall of the housing pot by means of a crimp connection, wherein the securing ring provides a first at least part-circumferential axial stop surface for the annular seal and, from the free rim end, a stop ring is inserted into the securing ring which provides a second at least part-circumferential axial stop surface for the annular seal.

Also, the technical object is solved for the connecting device in that on the connecting element a part of an anti-rotation securing device is present which corresponds with another part of the anti-rotation securing device that is present on the filter.

In an advantageous embodiment, the connecting element can comprise an axially acting stop relative to the connecting axis for defining an end position of the corresponding at least one filter-associated connecting element. With the at least one stop, it can be prevented that the filter is moved past the end position in axial direction during mounting. The corresponding forces can act in this context substantially on the at least one stop associated with the connection-associated connecting element. A mechanical loading of the sealing device can be reduced in this way.

In a further advantageous embodiment, the part of the anti-rotation securing device associated with the connecting device can be a groove that extends at least partially circumferentially and is open in radial outward direction, wherein the rim of an opening of a securing sleeve which is extending coaxially away from a housing cover of the filter can be locked in the groove. In this way, a locking connection for realizing the anti-rotation securing device can be formed in a simple way.

In a further advantageous embodiment, the connecting element can be a central connecting socket that preferably comprises an external thread, wherein the groove can be present on a wall surface of the connecting socket. In this way, a rotary and/or plug-in connection, in particular screw connection, an anti-rotation securing device, and a fluid connection can be realized with the connecting socket.

In a further advantageous embodiment, the connecting socket, on a side which is facing away from the filter, can be provided with a projecting shaft shoulder adjoining the groove which can provide an axially acting stop for the securing sleeve of the filter. A simple stop can be realized with the shaft shoulder.

In a further advantageous embodiment, the connecting socket, beyond the groove, can have an insertion ramp which tapers toward the filter. In this way, the securing sleeve upon mounting of the filter housing, in particular of the filter, can be guided better by a connecting device.

Advantageously, the insertion section can comprise at least one sealing receptacle, extending circumferentially relative to the connecting axis and open in radial outward direction, for a radially acting annular seal. The annular seal can be simply arranged, positioned, and/or secured in the sealing receptacle.

Advantageously, at least one annular seal can be pre-mounted on the insertion section. The filter housing can be mounted with the attachment section across the annular seal on the insertion section.

Alternatively or additionally, at least one annular seal can be pre-mounted on the filter housing. The annular seal in this case can be applied with the attachment section to the insertion section, in particular can be inserted into the sealing receptacle.

Advantageously, the at least one sealing receptacle can be delimited radial inwardly at least partially by a connection-associated radial sealing surface. In this way, the annular seal can be additionally pressed radial inwardly against the connection-associated radial sealing surface. In this way, a corresponding radial sealing action can be realized.

Optionally, the at least one annular seal can be radially supported radial inwardly on the connection-associated radial sealing surface.

The connection-associated radial sealing surface, the filter-associated radial sealing surface, and the annular seal can at least partially form a circumferential sealing device relative to the environment that is acting sealingly in radial direction relative to the connecting axis.

Advantageously, at least one sealing receptacle on its side which is facing away axially relative to the connecting axis from the end face of the insertion section can comprise at least one at least part-circumferential stop area for the at least one annular seal. In this way, it can be prevented that the annular seal on the corresponding side can escape axially out of the sealing receptacle.

Moreover, the at least one stop area can support the annular seal in axial direction in case of axial compression relative to the connecting axis. The axial compression of the annular seal can occur in particular by liquid pressure possibly acting in operation on the side of the annular seal which is facing away from the stop area.

Advantageously, the at least one sealing receptacle on its side which is facing the end face of the insertion section can comprise at least one liquid connection to a liquid-conducting area of the connecting device and/or of the filter. In this way, the annular seal can be loaded on this side by a liquid pressure. With the liquid pressure, the annular seal can be axially compressed relative to the connecting axis. Due to its elasticity in radial direction, the annular seal can yield in radial inward direction and radial outward direction. In this way, the annular seal can be widened or deformed in radial direction. The radial sealing action of the annular seal in radial inward direction and/or radial outward direction can thus be augmented.

Moreover, the object is solved according to the invention for the filter device with a filter housing according to the invention and a connecting device according to the invention.

In other respects, the features and advantages discussed in connection with the filter housing according to the invention, the filter according to the invention, the connecting device according to the invention, and the filter device according to the invention, and their respective advantageous configurations apply likewise among each other and vice versa. The individual features and advantages can of course be combined among each other, wherein further advantageous effects may result which surpass the sum of the individual effects.

### BRIEF DESCRIPTION OF THE DRAWINGS

Further advantages, features, and details of the invention result from the following description in which embodiments of the invention will be explained in more detail with the aid of the drawings. A person of skill in the art will consider the features disclosed in the drawing, the description, and the claims in combination expediently also individually and combine them to other meaningful combinations.

FIG. 1 shows schematically a longitudinal section of a filter system according to a first embodiment for motor oil of a motor oil circuit of an internal combustion engine, with an exchangeable filter which is exchangeably screwed onto a connecting device.

FIG. 2 is a schematic detail view of the filter system of FIG. 1 in the area of the connection of the exchangeable filter with the connecting device.

FIG. 3 is a schematic longitudinal section of a filter system according to a second embodiment.

FIG. 4 is a schematic isometric illustration of an exchangeable filter of a filter system according to a third embodiment.

FIG. 5 shows one half of a schematic longitudinal section of the filter system with the exchangeable filter of FIG. 4.

FIG. 6 is a schematic detail view of the longitudinal section of the filter system of FIG. 5 in the area of the connection of the exchangeable filter with a connecting device of the filter system.

FIG. 7 is an isometric illustration of an exchangeable filter of a filter system according to a fourth embodiment.

FIG. 8 is a plan view onto a connecting side of the exchangeable filter of FIG. 7.

FIG. 9 is a schematic longitudinal section of the exchangeable filter of FIGS. 7 and 8 along a section line IX-IX of FIG. 8.

FIG. 10 is a schematic detail view of the filter system with the exchangeable filter of FIGS. 7 to 9 in the area of the connection of the exchangeable filter with a connecting device of the filter system.

In the Figures, same components are provided with same reference characters.

### DESCRIPTION OF PREFERRED EMBODIMENTS

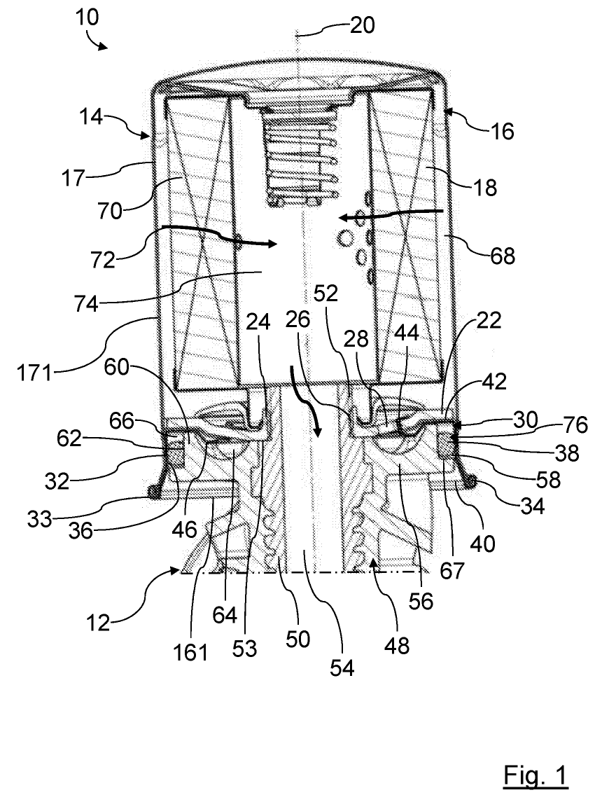

In FIG. 1, a filter system 10 according to a first embodiment for motor oil is shown in a longitudinal section. The filter system 10 is arranged in a motor oil circuit, not shown otherwise, of an internal combustion engine of a motor vehicle for filtration of the motor oil circulating therein.

The filter system 10 comprises a connecting device 12 with which a filter 14 is exchangeably connected. The connecting device 12 is connected fixedly with the internal combustion engine, for example, a frame of the internal combustion engine.

The filter 14 is designed as a so-called exchangeable filter. Such exchangeable filters are also known as so-called spin-on filters. The filter 14 comprises a filter housing 16 in which a filter element 18, designed in an exemplary fashion as a round filter element, is arranged so as to be non-exchangeable in the present embodiment. The filter housing 16 and the filter element 18 are coaxial to an axis 20.

When in the following “radial”, “axial”, “coaxial”, “circumferential” or the like is mentioned, this relates to axis 20, if nothing is indicated otherwise. In the present case, the axis 20 coincides with an element axis of the filter element 18, a filter axis of the filter 14, and a connecting axis of the filter 14 with the connecting device 12. For reasons of better clarity, in the following only the term axis 20 is used wherein, depending on the context, one or several of the aforementioned axes are meant. In other embodiments of the invention, at least two of the aforementioned axes can extend parallel or at a slant to each other.

The filter housing 16 comprises a housing pot 17. The housing pot 17, for example, is comprised of sheet metal. The housing pot 17 comprises at an end face which is facing the connecting device 12 an installation opening for the filter element 18. After the installation of the filter element 18, the installation opening is covered by a housing cover 22 of the filter housing 16.

The housing cover 22 comprises a coaxial connecting opening 24. The connecting opening 24 serves also as an outlet opening of the filter 14 for purified motor oil. The radial inner rim of the housing cover 22 which surrounds the connecting opening 24 comprises a coaxial inner thread 26.

Moreover, the housing cover 22 comprises a plurality of cover liquid passages 28 in the form of through openings which are realized as through bores, for example. The cover liquid passages 28 serve as inlet openings for the motor oil to be purified into the filter 14. The cover liquid passages 28 are located radially between the connecting opening 24 and the radial outer rim of the housing cover 22.

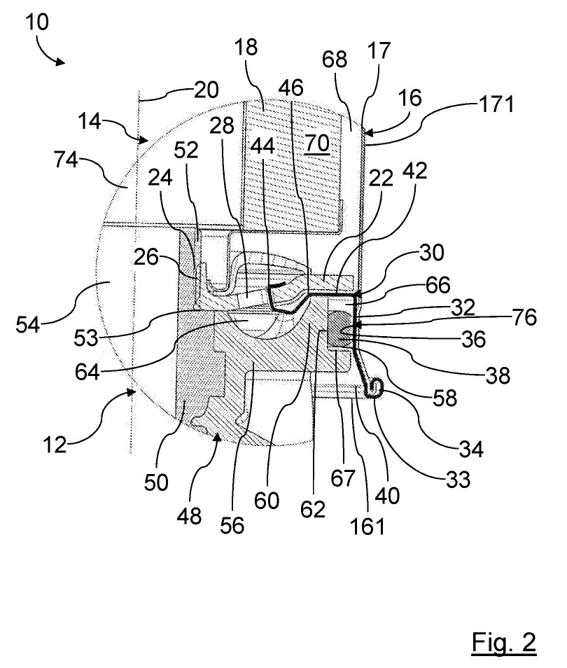

The housing cover 22 is secured by means of a coaxial securing ring 30, which is part of the filter housing 16, in the installation opening of the housing pot 17. A detail view of the filter system 10 in the area of the securing ring 30 is shown in FIG. 2.

The securing ring 30 is a formed part of sheet metal. The securing ring 30 comprises a coaxial cup-shaped attachment section in the form of a circumferential push-on section 32. The securing ring 30 is inserted into the installation opening of the housing pot 17 such that the open side of the push-on section 32 is pointing outwardly in axial direction. A circumferential wall of the push-on section 32 is contacting in this context the radial inner circumferential side of a circumferential wall 171 of the housing pot 17. The extension of the circumferential wall of the push-on section 32 corresponds to the extension of the circumferential wall 171 of the housing pot 17. The free rim of the circumferential wall of the push-on section 32 is connected by means of a crimp connection 34 with the free rim of the circumferential wall 171 of the housing pot 17.

At its radial inner circumferential side, the circumferential wall of the push-on section 32 forms a filter-associated radial sealing surface 36 for an annular seal 38. The filter-associated radial sealing surface 36 has a coaxial cylindrical extension. The annular seal 38 is designed as an O-ring seal. The annular seal 38 is elastic.

In a circumferential guide section 40, axial between the filter-associated radial sealing surface 36 and the free rim of the circumferential wall of the push-on section 32, the circumferential wall of the push-on section 32 and the section of the circumferential wall 171 of the housing pot 17 provided thereat widen approximately in a funnel shape outwardly in radial direction.

On its side which is axially facing the filter element 18, the circumferential wall of the push-on section 32 passes monolithically into a circumferentially and radially extending annular bottom section 42. With the bottom section 42, the securing ring 30 is resting against the facing side of the housing cover 22.

At its radial inner circumferential rim, the bottom section 42 has a plurality of holding tabs 44. The holding tabs 44 are arranged so as to be distributed circumferentially. Each holding tab 44 is correlated with one of the cover liquid passages 28. The holding tabs 44 are bent such that they engage the cover liquid passages 28. The housing cover 22 is secured by means of the holding tabs 44 on the securing ring 30. The securing ring 30 fixes the housing cover 22 on the filter housing 16.

Viewed radially, between the holding tabs 44 and the circumferential wall of the push-on section 32, a projection in the form of a circumferentially extending step 46 is formed on the bottom section 42. Viewed from the filter element 18, the step 46 rises in axial direction outwardly. In the area of the step 46, the housing cover 22 is provided with a corresponding projection.

In the following, the connecting device 12 is explained in more detail. The connecting device 12 comprises a base member 48 and a coaxial connecting socket 50. The base member 48 is comprised of plastic material, for example, produced by casting. The connecting socket 50 is comprised of metal.

The connecting socket 50 is embedded in the base member 48 with a section which is facing away from a side of the base member 48 that is facing the filter 14. On the side which is facing the filter 14, the connecting socket 50 projects axially out of the base member 48. The connecting socket 50 comprises a coaxial outer thread 52 on its radial outer circumferential side. The outer thread 52 forms with the inner thread 26 of the housing cover 22 a screw connection for attachment of the filter 14.

Axially between the outer thread 52 and the embedded area of the connecting socket 50, the latter has a step which provides an axial stop 53. The housing cover 22, when being screwed onto the connecting socket 50, is contacting the stop 53 in the end position of the filter 14.

The base member 48 comprises moreover mounting sections, which are not shown in the Figures, with which it can be attached to the frame part of the internal combustion engine, for example.

Moreover, the base member 48 comprises an inlet line, hidden in the Figures, for motor oil to be purified and an outlet line 54 for purified motor oil. The outlet line 54 passes across on the side of the connecting socket 50 facing the filter 14 and is formed here by the socket 50. The inlet line and the outlet line 54 serve as connecting lines. Outside of the base member 48, the inlet line and the outlet line 54 are connected respectively to the motor oil circuit.

On the side which is facing the filter 14, the base member 48 is embodied as an insertion section in the form of a plug-in section 56. In the plug-in section 56, the connecting socket 50 is arranged. The radial outer circumferential side of the plug-in section 56 is coaxial to axis 20. The radial outer circumferential side of the plug-in section 56 is stepped once inwardly in radial direction. It forms thereat a coaxial sealing receptacle 58 for the annular seal 38. The sealing receptacle 58 is open in radial outward direction and open axially toward the side of the plug-in section 56 which is facing the filter 14.

The sealing receptacle 58 is delimited in radial inward direction by a coaxial web 60. The web 60 extends in axial direction. The radial outer circumferential side of the web 60 forms a connection-associated radial sealing surface 62 for the annular seal 38. The connection-associated radial sealing surface 62 has a coaxial cylindrical shape. On the side facing the filter 14, the web 60 with the connection-associated radial sealing surface 62 projects past the annular seal 38 in axial direction.

In radial direction between the web 60 and the connecting socket 50, a coaxial annular depression 64 is arranged. The depression 64 is open in a direction toward the side of the plug-in section 56 which is facing the filter 14. The inlet line opens into the depression 64.

With the filter 14 mounted, the securing ring 30 is pushed with the push-on section 32 from the exterior onto the plug-in section 56, i.e., is attached. The axial extension of the radial inner circumferential side of the circumferential wall of the push-on section 32 as a whole is greater than the axial extension of the web 60. The filter-associated radial sealing surface 36, viewed axially, terminates with the sealing receptacle 58. The guide section 40 projects past the sealing receptacle 58 in axial direction. The free rim of the web 60 with its radial inner side can be supported radial outwardly on the step 46 of the securing ring 30 in radial direction.

A coaxial fluid space 66 is delimited radially between the connection-associated radial sealing surface 62 and the filter-associated radial sealing surface 36. The fluid space 66 is formed in an area of the sealing receptacle 58 which is not occupied by the annular seal 38. The fluid space 66 is connected by fluid connections, hidden in FIGS. 1 and 2, with the depression 64 and through the depression 64 is connected oil-conductingly with the inlet line.

Prior to mounting of the filter 14 on the connecting device 12, the annular seal 38 is placed from the side of the base member 48 facing the filter 14 into the sealing receptacle 58 of the plug-in section 56.

Subsequently, the filter 14, with the push-on section 32 leading, is first pushed with a push-on movement axial to the axis 20, i.e., axial to the connecting axis, onto the plug-in section 56. The guide section 40 serves in this context as a centering aid.

Upon pushing on the push-on section 32, the connecting socket 50 is guided to the connecting opening 24 of the housing cover 22. By means of a subsequent screwing movement, which constitutes a combined rotary and plug-in movement about the connecting axis 20, the filter 14 is screwed onto the connecting socket 50.

The guide section 40 serves as a mounting and centering aid during push-on and subsequent screwing movement. The annular seal 38 can axially glide along the radial inner circumferential side of the guide section 40 and can be guided into the area of the filter-associated radial sealing surface 36.

In the end position of the filter 14, the housing cover 22 contacts axially the stop 53 so that a further screwing movement is prevented. The stop 53 defines the axial end position of the filter 14.

In the end position of the filter 14, the annular seal 38 with its radial inner circumferential side is resting on the connection-side radial sealing surface 62 and with its radial outer circumferential side on the filter-associated radial sealing surface 36 so as to act sealingly in radial direction, respectively. The filter-associated radial sealing surface 36, the connection-associated radial sealing surface 62, and the annular seal 38 form a circumferential sealing device 76 which is acting sealingly relative to the environment in radial direction relative to the axis 20. The annular seal 38 enables due to its radial sealing action in connection with the axial extension of the filter-associated radial sealing surface 36 and the connection-associated radial sealing surface 62 an axial position tolerance beyond its function as annular seal. The sealing receptacle 58 and thus the fluid space 66 are delimited on the side which is facing the filter 14 by the bottom section 42 of the securing ring 30.

In operation of the internal combustion engine, motor oil from the motor oil circuit is conveyed for filtration through the inlet line first into the depression 64. Due to the fluid connection with the fluid space 66, the latter is loaded with oil pressure. The oil pressure in the fluid space 66 effects an axial compression of the annular seal 38. In this context, the annular seal 38 can be supported axially against the sidewall 67 of the sealing receptacle 58 which is axially opposite the bottom section 42. The sidewall 67 serves as a stop or stop area for the annular seal 38. The annular seal 38 yields elastically in response to the oil pressure in radial direction outwardly and inwardly and is thus more strongly pressed against the corresponding radial sealing surfaces 36 and 62. In this way, the radial sealing action of the annular seal 38 is augmented in operation. In this context, the web 60 can be supported with its free rim on the radial inner circumferential side of the step 46 and can thus form a counter bearing.

The motor oil to be purified passes from the depression 64 through the cover liquid passages 28 into an annular space 68 of the filter housing 16 surrounding the filter element 18.

The motor oil to be purified flows through a filter medium 70 of the filter element 18, indicated in FIG. 1 by arrows 72, in radial direction from the exterior to the interior, is purified therein, and reaches then an element interior 74 of the filter element 18.

From the element interior 74, the purified motor oil flows through the connecting opening 24, respectively, the connecting socket 50, into the outlet line 54. Through the outlet line 54, the purified motor oil is returned from the filter system 10 back into the motor oil circuit.

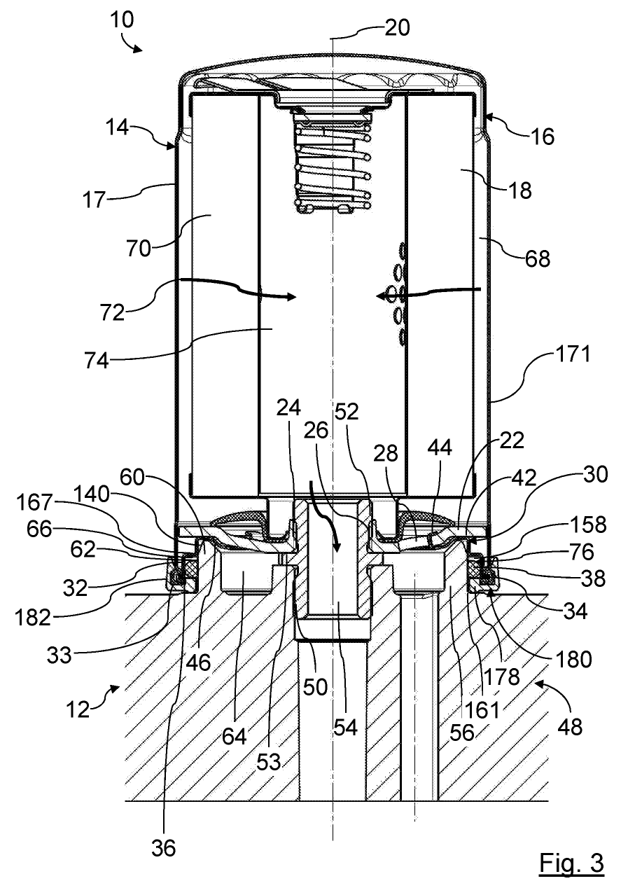

In FIG. 3, a filter system 10 according to a second embodiment is illustrated. Those elements that are similar to those of the first embodiment of FIGS. 1 and 2 are provided with the same reference characters. The second embodiment differs from the first embodiment in that a filter-associated sealing receptacle 158 is provided instead of the connection-associated sealing receptacle 58. The annular seal 38 is secured on the filter in the sealing receptacle 158.

A sidewall 167 that forms a first filter-associated axial stop section is realized by a corresponding step of the securing ring 30.

The second filter-associated axial stop section 178 on the side of the sealing receptacle 158 which is opposite the sidewall 167 is realized by a coaxial stop ring 180. The stop ring 180 can be comprised, for example, of metal or plastic material. The stop ring 180 comprises on its radial outer circumferential side a plurality of locking hooks 182. The locking hooks 182 engage radial outwardly the crimp connection 34. With the locking hooks 182, the stop ring 180 is detachably secured axial outwardly on the free rim of the housing pot 17.

When the filter 14 is mounted, the stop ring 180 is contacting axially an area of the base member 48 which is radial outwardly surrounding the plug-in section 56. When the filter 14 is separated from the connecting device 12, the stop ring 180 with the second filter-associated stop section 178 secures the annular seal 38 in the sealing receptacle 158.

Instead of the filter-associated guide section 40 of the first embodiment, a connection-associated guide section 140 is provided in the second embodiment. The connection-associated guide section 140 is in the form of a bevel on the radial outer side of the free rim of the web 60. The filter-associated stop ring 180 and the annular seal 38 are guided along the guide section 140 upon attachment of the filter 14.

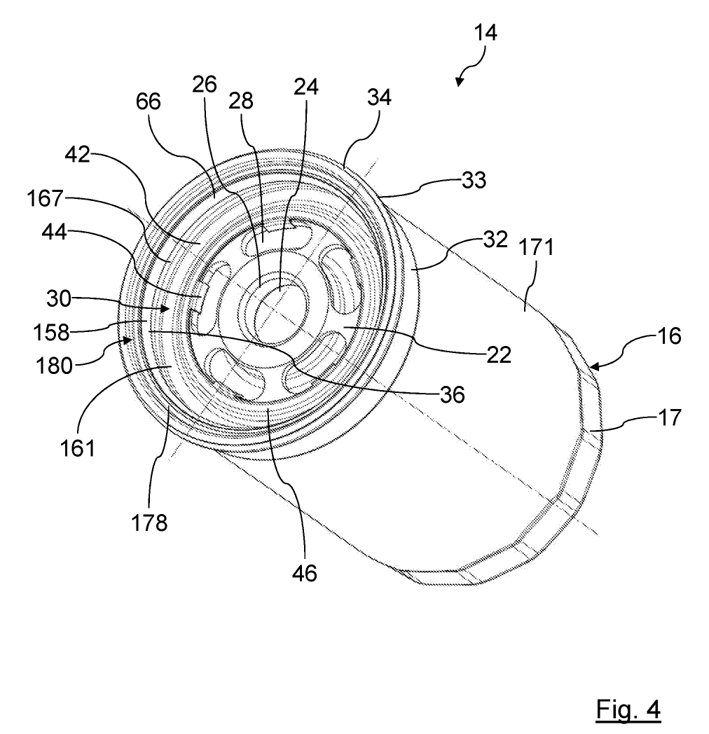

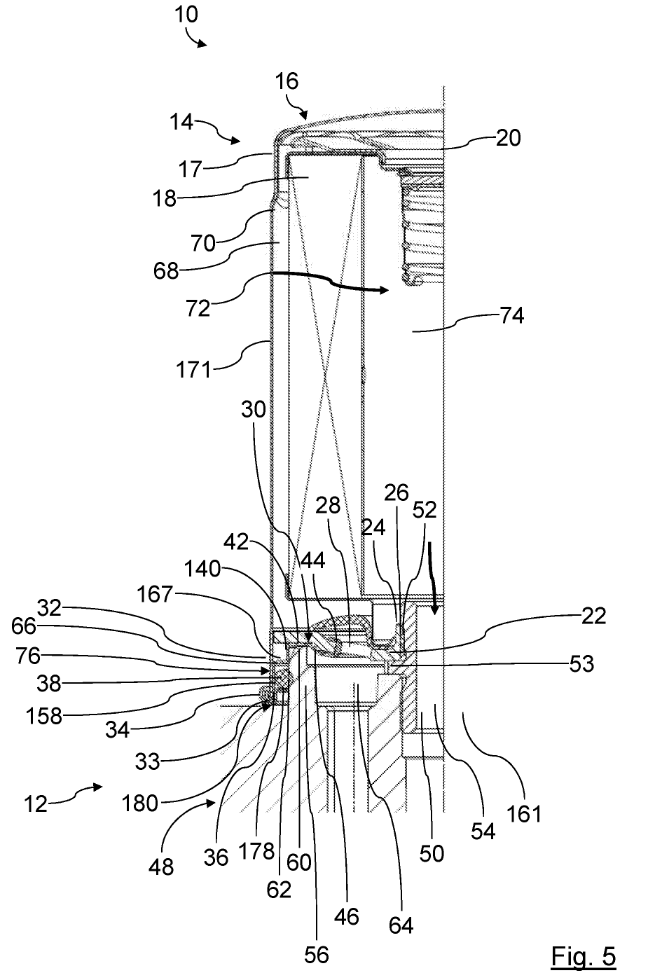

In FIGS. 4 to 6, a filter system 10 according to a third embodiment is illustrated. Those elements that are similar to those of the second embodiment of FIG. 3 are provided with the same reference characters. The third embodiment differs from the second embodiment in that from the end of the free rim 33 of the attachment section 32 a stop ring 180 is inserted into the securing ring 30. The stop ring 180 provides a second filter-associated axial stop section with a second circumferential axial stop surface 178 for the annular seal 38.

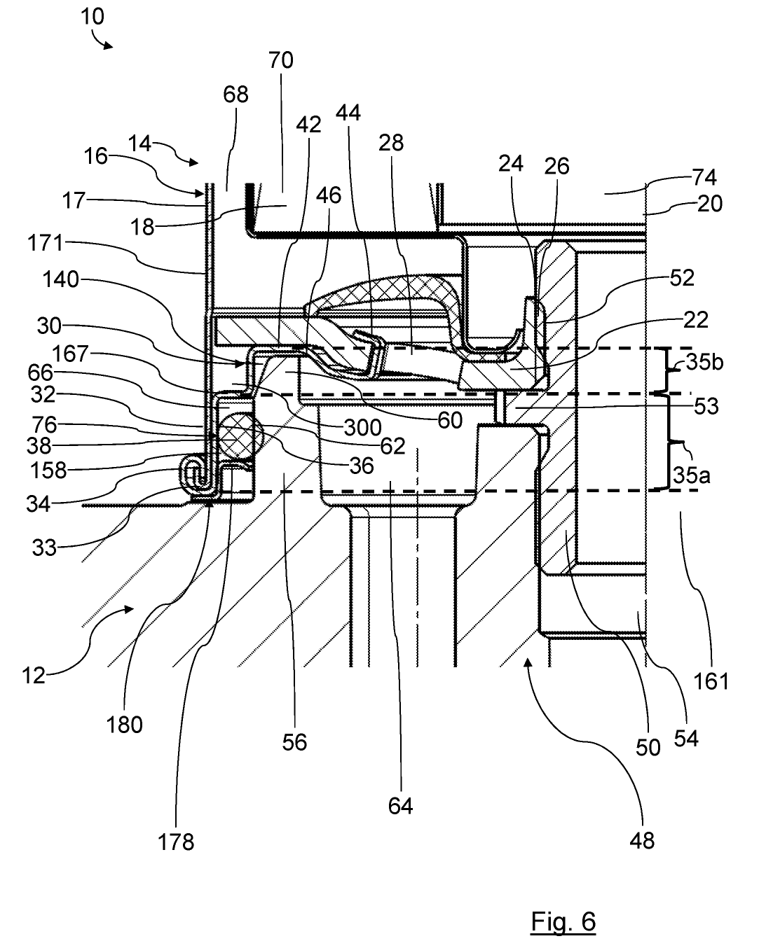

The securing ring 30, as illustrated in FIG. 6 in detail, is formed to follow closely with a predetermined axial extension the circumferential wall 171 of the housing pot 17 in a first section 35a that is near the free rim 33 of the attachment section 32. The securing ring 30 comprises a substantially cylindrical cross section in the first section 35a. The securing ring 30 comprises a reduced diameter section 300 in a second section 35b which is facing away from the free rim 33. The reduced diameter section 300 forms the first circumferential axial stop surface 167 for the annular seal 38.

The stop ring 180 is pressed from the end of the end face 161 of the filter housing 16 into the securing ring 30. The stop ring 180 has a substantially Z-shaped cross section. A leg of the Z extending perpendicular to the connecting axis 20 forms the second stop surface 178 for the annular seal 38. The leg is in an axial position where, in radial direction externally, the crimp connection 34 is present. The stop ring 180 does not project in axial direction father into the securing ring 30 than the crimp connection 34 is extending in axial direction away from the free rim 33.

The crimp connection 34 comprises a crimp that is bent in radial direction outwardly. The crimp does not generate a cross section restriction on the free rim 33 in relation to the circumferential wall 171 of the housing pot 17.

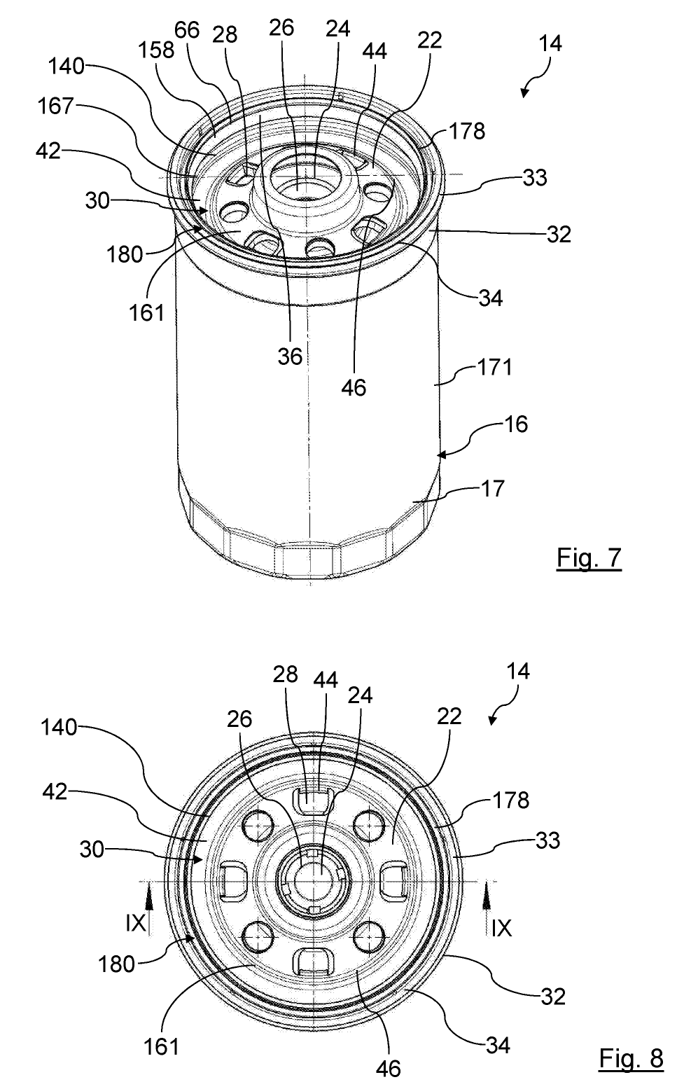

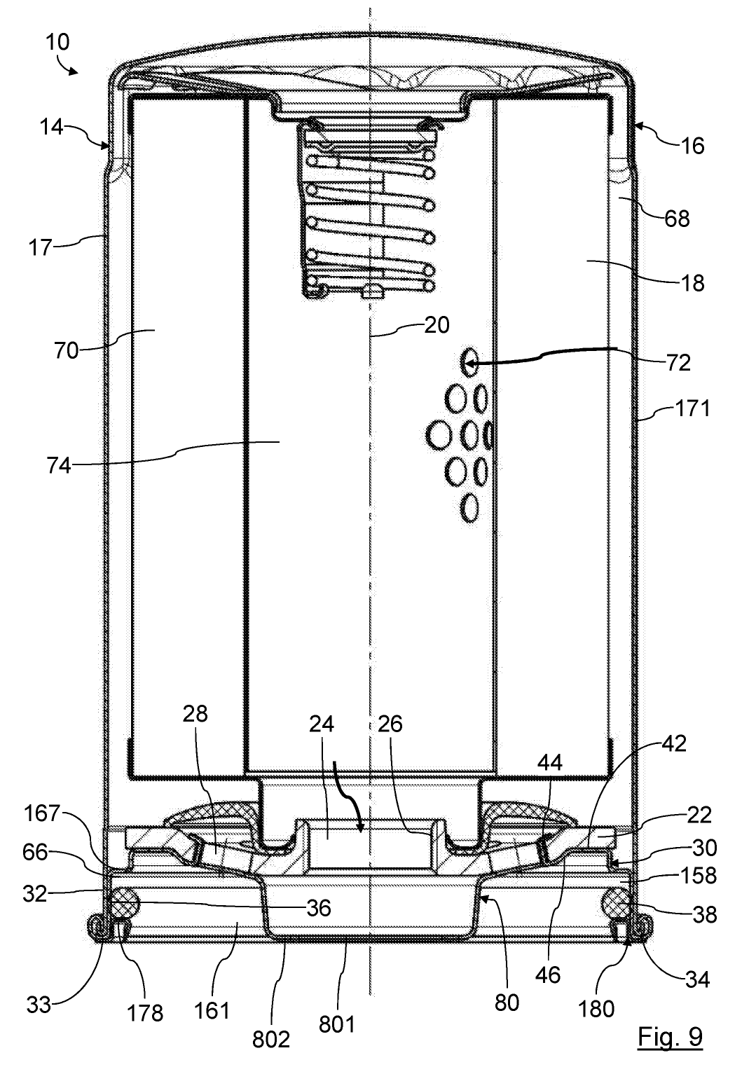

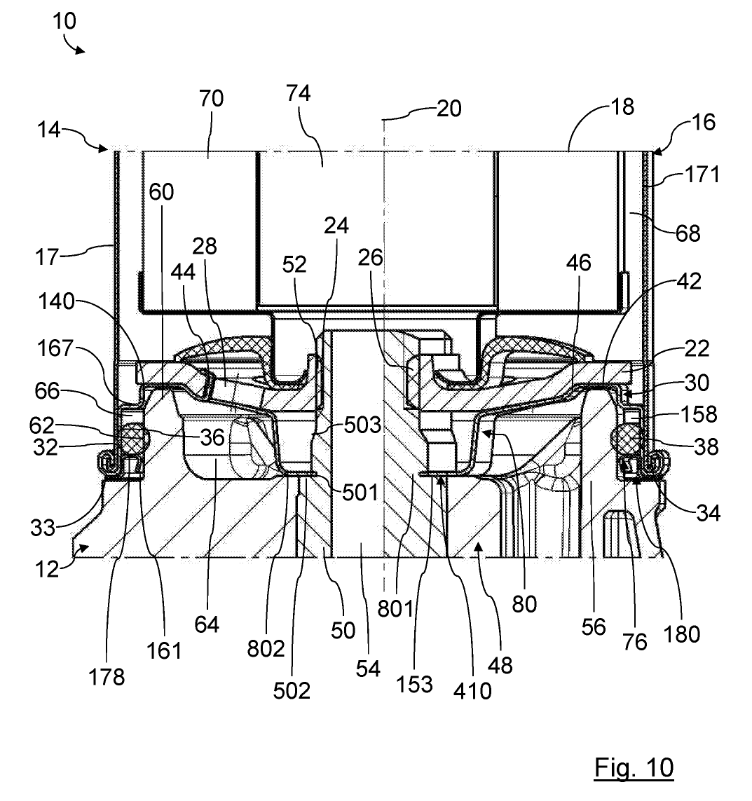

In FIGS. 7 to 10, a filter system 10 according to a fourth embodiment is shown. Those elements which are similar to those of the third embodiment of FIGS. 4 to 6 are provided with the same reference characters. The fourth embodiment differs from the third embodiment in that the filter housing 16 has a securing sleeve 80 at its open end face 161.

The securing sleeve 80 is arranged coaxially in the attachment section 32. The securing sleeve 80 has a central opening 801. The opening 801 is positioned in an end face 802 of the securing sleeve 80. The opening 801 is designed to receive in a mounting state the connecting socket 50 of the connecting device 12 of the filter device 10.

The securing sleeve 80 is resilient at least in axial direction. The securing sleeve 80 is comprised of a resilient material, for example, a thin-walled sheet metal. The securing sleeve 80 has a geometry that favors resilient properties. The securing sleeve 88 is monolithically formed in the securing ring 30 as a coaxial bulge of the securing ring 30.

The securing sleeve 80 extends in axial direction up to the level of a circumferential free rim 33 of the attachment section 32. The securing sleeve 80 ends at the same level as the rim 33 of the attachment section 32.

The rim of the securing sleeve 80 which delimits the opening 801 forms a part of an anti-rotation securing device 410. Another part of the anti-rotation securing device 410 in the form of a groove 501 is positioned at the connecting socket 50 of the connecting device 12. The groove 501 of the anti-rotation securing device 410 correlated with the connecting device 12 is arranged on the wall surface of the connecting socket 50 so as to be continuously outwardly open in the radial direction. The groove 501 and the rims of the opening 801 of the securing sleeve 80 correspond with each other for realization of the anti-rotation securing device 410. In the groove 501, the rim of the opening 801 of the securing sleeve 80 can be locked.

Beyond the groove 501 in the insertion direction, the connecting socket 50 has an insertion ramp 503 which tapers in the direction toward the filter 14.

On a side which is facing away from the filter 14, the connecting socket 50 comprises, adjoining the groove 501, a projecting shaft shoulder 502. The shaft shoulder 502 constitutes an axially acting stop 153 for the securing sleeve 80 of the filter 14 (a similar stop is also illustrated in the embodiment of FIG. 1 at reference character 53).

While specific embodiments of the invention have been shown and described in detail to illustrate the inventive principles, it will be understood that the invention may be embodied otherwise without departing from such principles.

What is claimed is:

1. A filter housing of an exchangeable filter of a filter device for liquids, the filter housing comprising:
a housing pot configured to accommodate at least one filter element;
at least one filter-associated connecting element configured to be connected by a rotary and/or plug-in connection relative to a connecting axis to a connecting device of the filter device for connecting the exchangeable filter;
a securing ring disposed at an end face of the filter housing and forming a cup-shaped attachment section, wherein, by of a rotary and/or plug-in movement relative to the connecting axis, the cup-shaped attachment section is attachable to a corresponding insertion section of the connecting device;
wherein the cup-shaped attachment section comprises a circumferential free rim at an open side of the cup-shaped attachment section and is connected at the circumferential free rim to a circumferential wall of the housing pot by a crimp connection;
wherein the cup-shaped attachment section comprises a sealing receptacle of at least one circumferential sealing device configured to act sealingly at least radially in a radial direction relative to the connecting axis;
wherein the sealing receptacle is open inwardly in the radial direction and comprises a radial sealing surface pointing inwardly in the radial direction and configured to support at least one annular seal;
wherein the securing ring comprises a first at least part-circumferential axial stop surface for the at least one annular seal in an axial direction of the connecting axis;
a stop ring inserted from the open side of the cup-shaped attachment section into the securing ring and providing a second at least part-circumferential axial stop surface for the at least one annular seal opposite the first at least part-circumferential axial stop surface in the axial direction.

2. The filter housing according to claim 1, wherein the securing ring is formed to follow closely with a predetermined axial extension the circumferential wall of the housing pot in a first section of the cup-shaped attachment section near the circumferential free rim, wherein the first section comprises a substantially cylindrical cross section, wherein the securing ring comprises, in a second section of the cup-shaped attachment section facing away from the circumferential free rim, a reduced diameter section that forms the first at least part-circumferential axial stop surface.

3. The filter housing according to claim 1, wherein the stop ring is pressed in from an end face of the filter housing into the securing ring

4. The filter housing according to claim 1, wherein the stop ring comprises a substantially Z-shaped cross section, wherein a leg of the Z is extending perpendicular to the virtual connecting axis and forms the second at least part-circumferential axial stop surface, wherein the leg of the Z is in an axial position where, in the radial direction externally, the crimp connection is located.

5. The filter housing according to claim 1, wherein the stop ring does not project farther into the securing ring in the axial direction than the crimp connection is extending in the axial direction away from the circumferential free rim.

6. The filter housing according to claim 1, wherein the crimp connection comprises a crimp that is bent in the radial direction outwardly and that does not produce on the circumferential free rim an inner cross section restriction relative to the circumferential wall of the housing pot.

7. The filter housing according to claim 1, further comprising a securing sleeve arranged coaxially on the cup-shaped attachment section at an open end face of the filter housing, wherein the securing sleeve has a central opening configured to receive at least partially in a mounted state of the filter a connecting element of the connecting device.

8. The filter housing according to claim 7, wherein the securing sleeve is formed monolithic in the securing ring as a coaxial bulge of the securing ring.

9. The filter housing according to claim 8, wherein the securing ring is a formed part.

10. The filter housing according to claim 7, wherein the securing sleeve extends in the axial direction at least to the level of the circumferential free rim.

11. The filter housing according to claim 10, wherein the securing sleeve ends in the axial direction at the same level as the circumferential free rim.

12. The filter housing according to claim 7, wherein the central opening is located in an end face of the securing sleeve, wherein a rim of the securing sleeve delimiting the central opening forms a first part of an anti-rotation securing device configured to interact with a second part of the anti-rotation securing device provided on the connecting element of the connecting device.

13. The filter housing according to claim 7, wherein the securing sleeve is resilient at least in the axial direction.

14. The filter housing according to claim 13, wherein the securing sleeve is comprised of a resilient material or has a geometry providing resilient properties.

15. The filter housing according to claim 13, wherein the securing sleeve is comprised of a resilient material and has a geometry providing resilient properties.

16. The filter housing according to claim 13, wherein the securing sleeve is comprised of a thin-walled sheet metal.

17. The filter housing according to claim 1, wherein the cup-shaped attachment section comprises a widened section that widens outwardly in the radial direction in a direction toward the circumferential free rim.

18. The filter housing according to claim 17, wherein the widened section is arranged, viewed in the axial direction, between the second at least part-circumferential axial stop surface and the circumferential free rim.

19. The filter housing according to claim 1, wherein the filter is a spin-on filter and the housing pot is comprised of sheet metal.

20. The filter housing according to claim 1, further comprising a housing cover, wherein the at least one filter-associated connecting element is provided on the housing cover, wherein the housing cover is connected by the securing ring to the housing pot.

21. The filter housing according to claim 20, wherein the securing ring comprises one or more fixation elements for fixation of the housing cover.

22. The filter housing according to claim 21, wherein the one or more fixation elements are bent tabs that engage behind the housing cover.

23. The filter housing according to claim 22, wherein the bent tabs are circumferentially distributed about the securing ring and the bent tabs each engage through a respective through opening of the housing cover.

24. The filter housing according to claim 20, wherein the securing ring comprises a bottom section and the housing cover is resting at least with sections thereof on the bottom section.

25. The filter housing according to claim 24, wherein the bottom section comprises at least one filter-associated projection that rises in the axial direction and is configured to support at least one corresponding connection-associated section of the connecting device.

26. An exchangeable filter of a filter device for liquids, the exchangeable filter device comprising at least one filter housing, therein the at least one filter housing comprises:
a housing pot configured to accommodate at least one filter element;
at least one filter-associated connecting element configured to be connected by a rotary and/or plug-in connection relative to a connecting axis to a connecting device of the filter device for connecting the exchangeable filter;
a securing ring disposed at an end face of the filter housing and forming a cup-shaped attachment section, wherein, by a rotary and/or plug-in movement relative to the connecting axis, the cup-shaped attachment section is attachable to a corresponding insertion section of the connecting device;
wherein the cup-shaped attachment section comprises a circumferential free rim at an open side of the cup-shaped attachment section and is connected at the circumferential free rim to a circumferential wall of the housing pot by a crimp connection;
wherein the cup-shaped attachment section comprises a sealing receptacle of at least one circumferential sealing device that is configured to act sealingly at least radially in a radial direction relative to the connecting axis;
wherein the sealing receptacle is open inwardly in the radial direction and comprises a radial sealing surface pointing inwardly in the radial direction and configured to support at least one annular seal;
wherein the securing ring comprises a first at least part-circumferential axial stop surface for the at least one annular seal in an axial direction of the connecting axis;
a stop ring inserted from the open side of the cup-shaped attachment section into the securing ring and providing a second at least part-circumferential axial stop surface for the at least one annular seal opposite the first at least part-circumferential axial stop surface in the axial direction.

27. A connecting device of a filter device for connecting an exchangeable filter for liquids, the connecting device comprising:
at least one connecting element configured to connect relative to a connecting axis by a rotary and/or plug-in movement for connecting a filter;
at least one part of a circumferential sealing device that is acting sealingly at least in a radial direction relative to the connecting axis;
an end-face insertion section to which a cup-shaped attachment section of a filter housing of the filter is attachable by a rotary and/or plug-in movement relative to the connecting axis;
wherein on the connecting element a first part of an anti-rotation securing device is arranged which corresponds to a second part of the anti-rotation securing device provided on the filter.

28. The connecting device according to claim 27, wherein the connecting element comprises an axial stop acting in the axial direction of the connecting axis and defining an end position of a corresponding at least one filter-associated connecting element.

29. The connecting device according to claim 27, wherein the first part of the anti-rotation securing device comprises an at least partially circumferentially extending groove that is open outwardly in the radial direction, wherein the groove is configured to lock a rim of an opening of a securing sleeve of the cup-shaped attachment section extending coaxially away from a housing cover of the filter.

30. The connecting device according to claim 29, wherein the connecting element is a central connecting socket comprising an outer thread, wherein the groove is present on a wall surface of the connecting socket.

31. The connecting device according to claim 30, wherein the connecting socket comprises on a side facing away from the filter a projecting shaft shoulder adjoining the groove and providing an axially acting stop for the securing sleeve of the filter.

32. The connecting device according to claim 30, wherein the connecting socket, beyond the groove in an insertion direction of the connecting socket, comprises an insertion ramp that tapers in a direction toward the filter.

33. A filter device for liquids, the filter device comprising:
an exchangeable filter comprising at least one filter housing comprising a housing pot configured to accommodate at least one filter element;
a connecting device comprising an insertion section and at least one connecting element;
wherein the exchangeable filter comprises at least one connecting element connectable relative to a connecting axis by a rotary and/or plug-in movement to the at least one connecting element of the connecting device;
wherein the at least one filter housing comprises at least a first part of at least one circumferential sealing device configured to act sealingly at least radially in a radial direction relative to the connecting axis and wherein the connecting device comprises at least a second part of the at least one circumferential sealing device;
wherein the at least one filter housing comprises a securing ring disposed at an end face of the at least one filter housing and forming a cup-shaped attachment section, wherein, by the rotary and/or plug-in movement relative to the connecting axis, the cup-shaped attachment section is attachable to the insertion section of the connecting device;
wherein the cup-shaped attachment section comprises a circumferential free rim at an open side of the cup-shaped attachment section and is connected at the circumferential free rim to a circumferential wall of the housing pot by a crimp connection;
wherein the cup-shaped attachment section comprises a sealing receptacle forming the first part of the at least one circumferential sealing device, wherein the sealing receptacle is open inwardly in the radial direction and comprises a radial sealing surface pointing inwardly in the radial direction and configured to support at least one annular seal;
wherein the securing ring comprises a first at least part-circumferential axial stop surface for the at least one annular seal in an axial direction of the connecting axis;
wherein the at least one filter housing comprises a stop ring inserted from the open side of the cup-shaped attachment section into the securing ring and providing a second at least part-circumferential axial stop surface for the at least one annular seal in the axial direction;
wherein on the at least one connecting element of the connecting device a first part of an anti-rotation securing device is arranged and wherein a second part of the anti-rotation securing device, configured to interact with the first part of the anti-rotation securing device, is provided on the exchangeable filter.
